(19) United States
(12) Patent Application Publication
(10) Pub. No.: US 2003/0101073 A1
(43) Pub. Date: May 29, 2003

(54) System and methods for strengthening and commercializing intellectual property

(76) Inventor: Curtis A. Vock, Boulder, CO (US)

Correspondence Address: Curtis A. Vock, Lathrop & Gage L.C., Suite 300, 4845 Pearl East Circle, Boulder, CO, 80301, US

(21) Appl. No.: 10/304,334

(22) Filed: Nov. 26, 2002

Related U.S. Application Data
(60) Provisional application No. 60/333,557, filed on Nov. 26, 2001.

(51) Int. Cl. G06F 17/60

(52) U.S. Cl. 705/1

(57) ABSTRACT

A system strengthens and commercializes intellectual property. A server posts, on-line, a plurality of pending IP, each pending IP including one or both of an image and associated text. A network connects with the server so that others may publicly access the pending IP. The server receives information from third parties regarding the pending IP; such information can include one or both of prior art and terms (to buy or license) for at least one of the pending IP. The server may process the prior art to automatically submit a statement to the patent office in regard to the prior art. The server may search databases connected with the network to identify one or both of companies and individuals associated with technology similar to the pending IP, and automatically notify one or both of the companies and individuals about the pending IP.

### RELATED APPLICATIONS

This application claims priority to U.S. Provisional Application No. 60/333,557 which is hereby incorporated by reference.

### BACKGROUND OF THE INVENTION

The patent systems around the world are quite complex and costly. An average U.S. Patent costs $20,000 from start to issuance, and typically encompasses a process of one to five years. In that time, the “idea” for the patent may become stale; the original inventor may also never benefit from the patent, even if he can afford it. Moreover, once a patent is issued, the “idea” for the patent may have been conceived of, and developed, by another company; the “cost” associated with settling a dispute has risen over the intervening time to obtain the patent. The cost of litigation is rising every day.

There is a need to simplify this process and to save time.

### SUMMARY OF THE INVENTION

It is, accordingly, one feature of the invention to provide a system that encourages the selling of patent applications and ideas without the necessity of obtaining an actual patent. Another object of the invention is to assist inventors in commercializing ideas, patents, and particularly patent applications. Other features of the invention are apparent within the description that follows.

In one aspect, the system includes a database (or “server”) of ideas. These ideas are preferably filed as patent applications (e.g., provisional applications) in the U.S. Patent Office (or other international patent office). As used herein, each idea that has a patent pending in the system is referred to as “pending IP.” Preferably, the system posts the pending IP as a picture of the main embodiment and with a brief description, so that users of the Internet may review, and know of, the pending IP. Alternatively, the system may post the entire patent application of the pending IP, or a subset thereof.

In another aspect, the system conducts automatic searching of databases, such as Internet databases, to locate and identify inventors and companies that have, or are developing, technology that is similar to pending IP. Preferably, this searching includes searching of patent databases, such as public databases within the U.S. Patent Office. In one aspect, each pending IP has one or more descriptive terms that sufficiently define the pending IP for this searching. For example, if the pending IP is an idea for a car tire, the descriptive terms might include “automotive” and “tire.” In another example, if the pending IP covers an idea for a topical sunscreen that goes on colored and then goes clear upon application, then the descriptive terms might include “disappearing colored sunscreen.”

Once inventors or companies are identified as having or developing technology similar to pending IP, the system of one aspect generates a notice and sends the notice to the inventors and/or companies. The notice serves to notify the inventors and/or companies that the associated pending IP is similar to the technology of the inventors and/or companies. In the U.S., in the event that the inventors and/or companies also have pending patent applications relating to the similar technology, then they are under legal obligations to inform the patent office of the notice, typically in the form of an information disclosure statement. This obligation encourages the inventors and/or companies to purchase the pending IP related to their similar technology. Specifically, if a person or company becomes aware of pending IP—such as by receiving the notice, or by reviewing posted pending IP in the database—that person or company must disclose the pending IP in pending patent applications of that person or company if the pending IP is materially related to the technology of the pending patent applications; such an obligation encourages negotiations for the pending IP. In one aspect, the system facilitates (automatically or semi-automatically) on-line negotiations to sell and/or license the pending IP.

In still another aspect, a person or company may seek to devalue or diminish the likelihood of an actual patent issuing on pending IP by communicating prior art (e.g., patents or articles relating to the pending IP) to the system. In such an event, the owner of the pending IP has a like-obligation to report the prior art to the patent office. Accordingly, the system of one aspect facilitates the identification and posting of such prior art—which may make it impossible to obtain a patent on the pending IP, saving everyone (inventor, assignee and other companies) time and money, since it is very expensive to invalidate an issued patent through litigation or reexamination.

In still another aspect, the system searches prior art databases for prior art similar to the descriptive terms, and automatically prepares and reports an information disclosure statement based on prior art located during that search. In this way, the system seeks to validate the value of a pending patent application early and before actual issuance. Such validation seeks to increase the likelihood of issuance of the pending IP, making it more likely that someone desiring to buy the pending IP may do so with confidence it will actually issue. Moreover, the value of the pending IP is strengthened, since a more thorough prior art search is conducted. Prior art submitted by third-party companies, and relative to certain pending IP, may also be automatically submitted as an information disclosure statement to the patent office.

In yet another aspect, the system may perform services for third-parties wishing to post pending IP, and/or wishing to strengthen pending IP. By way of example, for a service fee, the system may perform services for third parties, including posting their IP, searching for prior art, and/or seeking other prior art (through searching and/or through prior art submitted to the system from still other third parties) for posting with the IP.

### BRIEF DESCRIPTION OF THE DRAWINGS

A more complete understanding may be obtained by reference to the drawings, in which:

FIG. 1 shows a block schematic view of a system of the invention; and

FIG. 2 shows a flowchart illustrating one process of the system of FIG. 1.

### DETAILED DESCRIPTION OF THE DRAWINGS

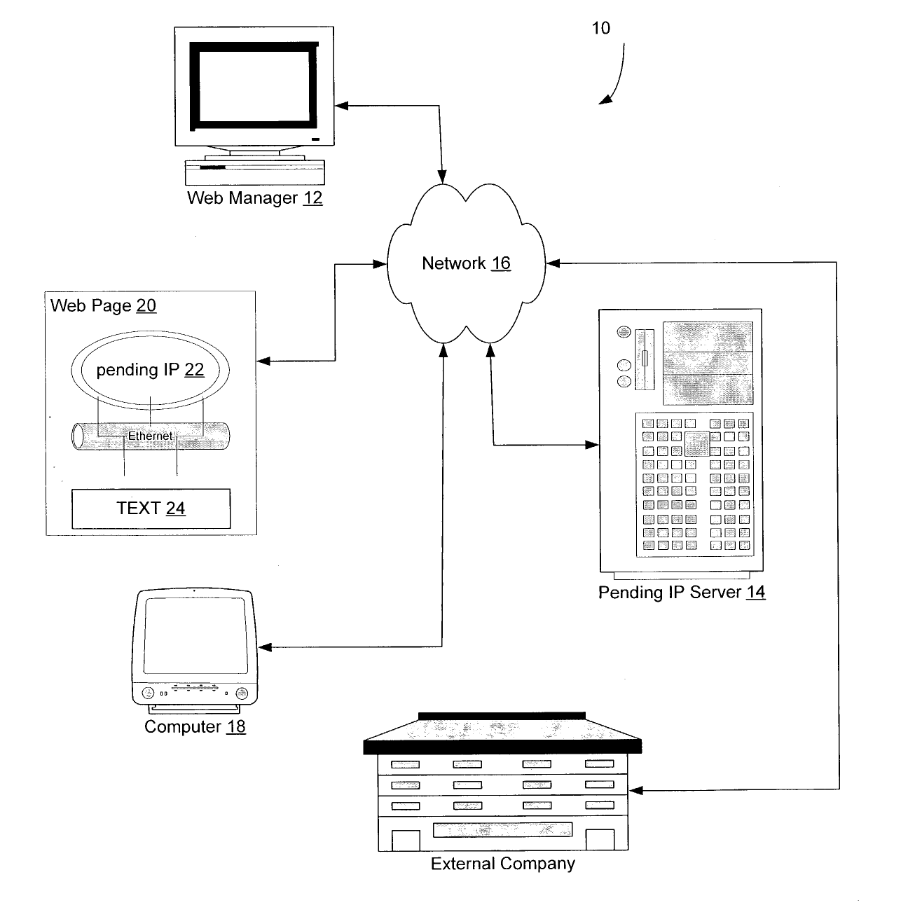

FIG. 1 shows a system 10 to strengthen and commercialize pending IP. System 10 includes a manager 12 and a pending IP server 14 connected together by a network 16 (e.g., the Internet). One or more ideas are packaged and stored within server 14 as pending IP. In operation, manager 12 posts the pending IP with server 14 so that persons (e.g., a person at computer 18) connected to network 16 may view selected pending IP; by way of example, exemplary pending IP 22 may be displayed within a web page 20. Preferably, each page 20 also describes pending IP 22, such as through text within a text box 24. Other computers such as computer 18 may reside within a company such as company 26 so that others may review pending IP (e.g., pending IP 22) of server 14.

In addition, manager 12 and/or server 14 may send notices to computer 18 (or alternatively within computers of company 26) informing users of such computers of pending IP. In this way, system 10 puts these users on notice so that they may become interested in buying the pending IP. Further, if the users or company 26 has materially similar patents pending within the U.S. patent office, this notice obligates the users or company 26 to inform the U.S. patent office of the pending IP. This notice may also automatically occur, without notice, if the users or company 26 visits web site 20 and sees materially relevant pending IP 22. Notices sent to company 26 may take the form of regular mail; however email is preferred. Faxes may also be sent, automatically, as a notice.

In one embodiment, system 10 connects with a database 30; database 30 may include patent and prior art information searchable by manager 12 and/or server 14. System 10 searches database 30 for prior art relating to one or more of the pending IP within server 14; if prior art is located, system 10 may automatically prepare and dispatch an information disclosure statement to the U.S. patent office, notifying the patent office of the prior art. In this way system 10 strengthens any subsequent issuance of pending IP as more prior art will be cited with the associated patent. Searching for prior art may utilize text within text box 24 as “descriptive text” for the pending IP, utilizing the descriptive text to search database(s) 30. Database 30 may also comprise a database such as a public database searchable through the Internet. Database 30 may also illustrate two or more databases at different locations, and/or may include a dedicated database unique to system 10 (e.g., database 30 may be part of pending IP server 14, for example).

In one embodiment, prior art may also be submitted to manager 12 and/or server 14 by computer 18 and/or company 26. For example, computer 18 may submit an electronic version (e.g., a PDF file) of a patent or article to manager 12 and/or server 14 that substantially anticipates pending IP 22; this constitutes notice for the owner of such pending IP 22 and an information disclosure statement may also be prepared and submitted for this prior art. In this way, system 10 reduces the likelihood of issuing patents if material prior art exists; and world-wide users of system 10 may thus provide prior art to affect the issuance of pending IP 22 in either positive or negative ways: in positive ways, by enhancing the value of a subsequently issued patent, by increasing cited prior art in a resulting patent; or in negative ways, by helping to invalidate, diminish or stall the issuance of the pending IP.

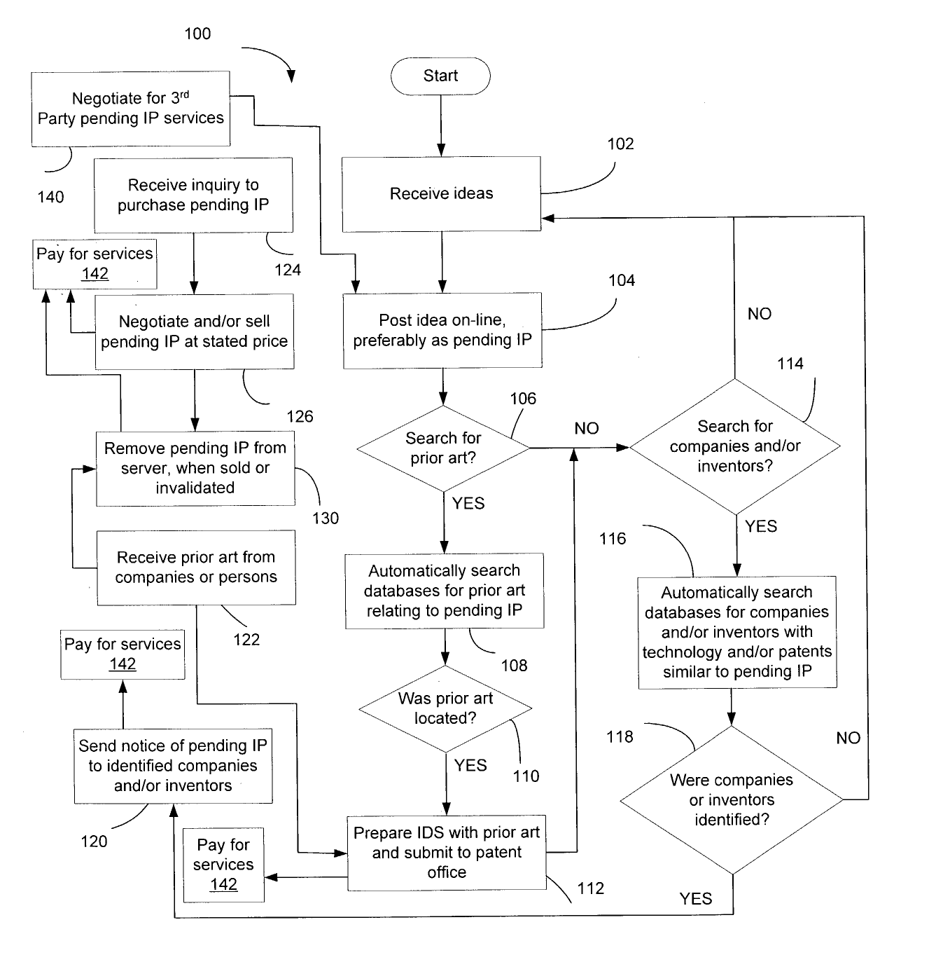

FIG. 2 illustrates a flowchart 100 one process suitable for processing, strengthening and commercializing pending IP of system 10, FIG. 1. After start, at step 102, system 10 receives ideas from inventors desiring to use system 10. If elected, an idea is posted on-line as a picture and associated text (step 104); preferably the idea is also filed as a pending patent application, making the posted idea also “pending IP.” Optionally, system 10 may search for prior art (step 106), such as within database 30. If a search is conducted, system 10 searches one or more databases (e.g., a patent office database 30) to find prior art (step 108). If prior art is located (step 110), that prior art is bundled as an information disclosure statement and sent to the patent office (step 112).

Optionally, system 10 may search for inventors and/or companies engaged in technology relating to pending IP (step 114), such as through the Internet or other databases 30. If this search is conducted, system 10 searches one or more databases to identify such inventors and/or companies, if existing (step 116). If such companies and/or inventors are identified (step 118), a notice is generated (step 120) to inform the companies and/or inventors of the pending IP; the notice of step 120 may be an email notice, fax, or mail generated automatically by system 10.

System 10 may also receive (step 122) prior art from outside sources, such as from the companies and/or inventors of company 26, FIG. 1. If received, system 10 bundles that prior art as an information disclosure statement and sends it (step 112) to the patent office. If however the prior art anticipates the pending IP, system 10 may remove the pending IP from the server (step 130). System 10 may also receive (step 124) inquiries to purchase pending IP, such as when a company learns that the pending IP exists after receiving notice, or when a company 26 views web page 20, FIG. 1. System 10 may preset a price for the pending IP and state the price in the text box posted on-line, or system 10 may negotiate for the pending IP (using upper and lower limits of value for an acceptable sale) in step 126. If sold, system 10 may remove the pending IP from the server (step 130).

In one embodiment, system 10 may offer services, for a fee, that embody processes outlined in process 100. For example, in step 140, system 10 (e.g., through server 14) may negotiate (for a fixed fee, or through on-line negotiations) with a third party to post pending IP (step 104), search for and report prior art (steps 108 and 112), search for and notify (steps 114-120) other companies with similar technologies, and/or sell pending IP (steps 124-130). System 10 receives a fee (illustratively shown as payment steps 142) for such services such as through a bank transaction; such transactions may occur at one or more locations, such as shown in FIG. 2 by steps 142.

Since certain changes may be made in the above methods and systems without departing from the scope hereof, it is intended that all matter contained in the above description or shown in the accompanying drawing be interpreted as illustrative and not in a limiting sense. It is also to be understood that the following claims are to cover all generic and specific features described herein, and all statements of the scope of the invention which, as a matter of language, might be said to fall there between.

What is claimed is:

1. A method for strengthening and commercializing intellectual property, comprising the steps of;
posting an idea on-line;
searching for one or both of companies and individuals engaged in technology similar to the idea; and
notifying one or both of the companies and individuals of the idea through a network.

2. A method of claim 1, the step of posting comprising applying for a patent application on the idea.

3. A method of claim 2, the step of posting comprising posting pending IP.

4. A method of claim 1, the step of notifying comprising automatically notifying the companies and individuals through the Internet.

5. A method of claim 4, further comprising utilizing email to notify the companies and individuals.

6. A method of claim 1, the step of posting comprising posting a picture and associated text on a web page.

7. A method of claim 1, further comprising the step of automatically searching for prior art by utilizing the text to search on-line databases for prior art.

8. A method of claim 7, further comprising automatically reporting the prior art to the patent office if prior art is located in the step of searching.

9. A method of claim 1, further comprising the steps of receiving on-line information indicative of the idea and determining whether to post the idea, or not.

10. A method of claim 1, further comprising receiving prior art, relevant to a particular idea, through the network and from one or both of individuals and companies.

11. A method of claim 10, further comprising reporting the prior art to the patent office.

12. A method of claim 1, further comprising receiving, through the network, terms for the idea.

13. A method of claim 12, the terms including one of purchase and licensing terms.

14. A method of claim 1, the step of posting comprising posting a price for the idea, and further comprising automatically accepting the terms if the price is met by on-line negotiations for the idea.

15. A system for strengthening and commercializing intellectual property, comprising:
a server for posting, on-line, a plurality of pending IP, each pending IP including one or both of an image and associated text;
a network connected with the server for accessing the pending IP publicly; the server receiving information from third parties regarding the pending IP, the information including one or both of prior art and terms for at least one of the pending IP.

16. A system of claim 15, the server processing the prior art to automatically submit a prior art statement to the patent office in regard to the prior art.

17. A system of claim 15, the server processing the terms to automatically agree to or deny the terms for the at least one pending IP.

18. A system of claim 17, the server deleting the at least one pending IP in the event that the terms are met.

19. A system of claim 15, the server deleting the at least one pending IP in the event that the prior art anticipates the at least one pending IP.

20. A system of claim 15, the server searching databases connected with the network to identify one or both of companies and individuals associated with technology similar to the pending IP, and automatically notifying one or both of the companies and individuals about the pending IP.

21. A system of claim 20, the server sending email to automatically notify the companies and individuals.

22. A system of claim 15, further comprising means to negotiate with a third-party for performing services associated with IP of the third-party.

23. A system of claim 22, the services comprising one or more of posting pending IP, searching for prior art, automatically posting prior art, receiving and processing prior art from other third parties, selling pending IP, and licensing pending IP.
